(19) United States
(12) Patent Application Publication
(10) Pub. No.: US 2026/0307103 A1
(43) Pub. Date: Oct. 8, 2026

(54) METHOD OF MANUFACTURING TREATED MEDIUM AND MANUFACTURING APPARATUS

(71) Applicant: BROTHER KOGYO KABUSHIKI KAISHA, NAGOYA (JP)

(72) Inventors: Makito IGUCHI, Nagoya (JP); Katsuya ONO, Nagoya (JP); Shogo SHIBAYAMA, Nisshin (JP)

(73) Assignee: BROTHER KOGYO KABUSHIKI KAISHA, NAGOYA (JP)

(21) Appl. No.: 19/635,954

(22) Filed: Apr. 1, 2026

(30) Foreign Application Priority Data
Apr. 2, 2025 (JP) 2025-061369

(51) Int. Cl. B05D 3/14; B05C 1/02; B05C 9/12; B05D 1/28

(52) U.S. Cl. CPC B05D 3/145; B05C 1/02; B05C 9/12; B05D 1/28

(57) ABSTRACT

A method of manufacturing a treated medium by performing a treatment on a medium may include applying a liquid comprising a resin to the medium, and performing a corona discharge on at least a region of the medium where the liquid has been applied.

### REFERENCE TO RELATED APPLICATION

This application claims priority to Japanese Patent Application No. 2025-061369 filed on Apr. 2, 2025. The entire content of the priority application is incorporated herein by reference.

### BACKGROUND ART

A medium containing polyethylene is known. This medium has moderate slipperiness.

### SUMMARY

The disclosure herein provides a technology for adjusting the slipperiness of a medium.

Disclosed herein is a method of manufacturing a treated medium by performing a treatment on a medium. The method may include applying a liquid comprising a resin to the medium, and performing a corona discharge on at least a region of the medium where the liquid has been applied.

According to the method above, the liquid comprising a resin is first applied to a medium. Thereby, a resin layer comprising the resin in a relatively large amount is formed on a surface of the medium. Subsequently, a corona discharge is performed on at least a region of the medium where the liquid has been applied. When electrons emitted by the corona discharge collide with molecules in ambient air, oxygen radicals and/or ozone are generated. Further, when the electrons emitted by the corona discharge reach the resin layer, polymer main chain and/or side chains of the resin in the resin layer are cleaved. The cleaved main chain and/or side chains react with the oxygen radicals or ozone in the ambient air, thereby introducing polar groups such as hydroxyl, carbonyl, and carboxyl groups onto the surface of the resin layer. This increases surface free energy of the medium, increasing adhesion of the medium to another medium and reducing the slipperiness of the medium.

Also disclosed herein is a manufacturing apparatus configured to manufacture a treated medium by performing a treatment on a medium. The manufacturing apparatus may include an applier configured to apply a liquid comprising a resin to the medium, and a discharger configured to perform a corona discharge on at least a region of the medium where the liquid has been applied.

### BRIEF DESCRIPTION OF DRAWINGS

FIG. 1 illustrates a configuration of a surface treatment apparatus.

### DESCRIPTION

### (Configuration of Surface Treatment Apparatus 10)

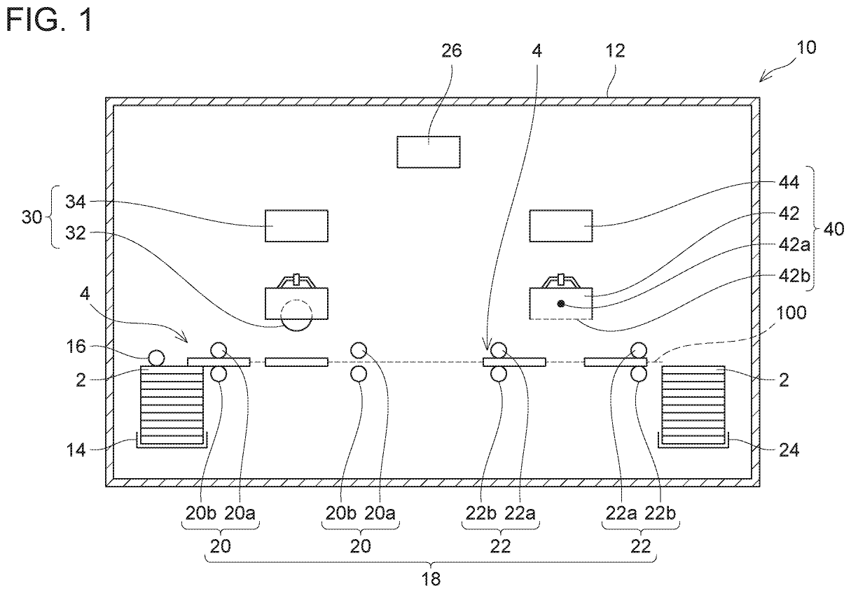

Referring to the drawing, a surface treatment apparatus 10 according to an embodiment is described. As illustrated in FIG. 1, the surface treatment apparatus 10 is a manufacturing apparatus configured to manufacture treated media 2 by applying a treatment liquid to the media 2 and then performing a corona discharge on at least a region of each medium 2 where the treatment liquid has been applied. Thus, the treated media 2 have lower slipperiness than untreated media 2. The surface treatment apparatus 10 is used in a state of being placed on a floor or a rack. However, in other embodiments, the surface treatment apparatus 10 may be used in a state of being placed on a desk.

The surface treatment apparatus 10 comprises a housing 12, a feed tray 14, a feed roller 16, a conveyor 18, a feed-out tray 24, and a controller 26. The controller 26 is communicably connected to each unit/device of the surface treatment apparatus 10. Thus, the controller 26 can control each unit/device of the surface treatment apparatus 10. Elements housed in the housing of the surface treatment apparatus 10 are depicted in FIG. 1 for illustrative purposes. However, the elements of the surface treatment apparatus 10 need not necessarily be arranged at the positions as illustrated.

The feed tray 14 is detachably supported by the housing 12. The feed tray 14 supports the media 2. A user can take out the feed tray 14 to the outside of the housing 12 to stack the media 2 on the feed tray 14. The surface treatment apparatus 10 is supplied with the media 2 by the feed tray 14 being placed back into the housing 12.

The feed roller 16 contacts the upper surface of the uppermost medium 2 among the media 2 supported on the feed tray 14. The feed roller 16 is rotated by a conveyor motor. When the feed roller 16 rotates, the uppermost medium 2 is fed from the feed tray 14.

The conveyor 18 conveys the media 2 fed through the feed roller 16 to the feed-out tray 24. The conveyor 18 comprises two first roller pairs 20 and two second roller pairs 22.

Each of the two first roller pairs 20 comprises a first conveyor roller 20a and a first pinch roller 20b. Contact between the first conveyor roller 20a and the first pinch roller 20b forms a nip 4. The two first roller pairs 20 are rotated by the conveyor motor. The two first roller pairs 20 rotate while nipping the media 2, to convey the media 2 from the feed roller 16 toward the second roller pairs 22. The number and arrangement of the first roller pairs 20 are not particularly limited.

Each of the two second roller pairs 22 comprises a second conveyor roller 22a and a second pinch roller 22b. Contact between the second conveyor roller 22a and the second pinch roller 22b forms a nip 4. The two second roller pairs 22 are rotated by the conveyor motor. The two second roller pairs 22 rotate while nipping the media 2, to convey the media 2 toward the feed-out tray 24. The number and arrangement of the second roller pairs 22 are not particularly limited.

The media 2 are fed out from the conveyor 18 onto the feed-out tray 24. The feed-out tray 24 supports the media 2.

A conveyance path 100 along which the media 2 are conveyed is formed between the feed tray 14 and the feed-out tray 24. While the media 2 are conveyed along the conveyance path 100, the treatment liquid is applied to the media 2 and then a corona discharge is performed on at least a region of each medium 2 where the treatment liquid has been applied.

The surface treatment apparatus 10 further comprises an applier 30. The applier 30 comprises a roller 32 and a controller 34. The controller 34 controls the roller 32 based on instructions from the controller 26. The controller 34 may also adjust the position of the roller 32. The controller 34 rotates the roller 32 to which the treatment liquid adheres to apply the treatment liquid onto the media 2. The treatment liquid is thereby applied onto the entire surface of each medium 2. The controller 34 may control a treatment liquid supplier configured to supply the treatment liquid to the roller 32 to supply the treatment liquid to the surface of the roller 32. The specific configuration of the applier 30 is not particularly limited.

The surface treatment apparatus 10 further comprises a discharger 40. On the conveyance path 100, the discharger 40 is located downstream of the applier 30. The discharger 40 comprises a charger 42 and a controller 44. The charger 42 is located above the conveyance path 100. In this embodiment, the charger 42 is a scorotron charger. The charger 42 comprises a charging wire 42a and a grid 42b. The grid 42b is located between the charging wire 42a and the conveyor 18. The controller 44 controls the charger 42 based on instructions from the controller 26. The controller 44 controls a charging-voltage applying circuit to apply a charging voltage to the charging wire 42a. The controller 44 controls a grid-voltage applying circuit to apply a grid voltage to the grid 42b. By applying the charging voltage to the charging wire 42a and applying the grid voltage to the grid 42b, a corona discharge is generated. The corona discharge is thereby performed to the media 2 on the conveyance path 100. The specific configuration of the discharger 40 is not particularly limited. For example, in other embodiments, the charger 42 may be a corotron charger.

### (Media)

The media 2 are not particularly limited. Examples of the media 2 may include, for example, paper materials, films, and OHP sheets. Examples of the paper materials may include, for example, plain paper, recycled paper, high-quality paper, thin paper, thick paper, glossy paper, coated paper, matte coated paper, coated cardboard, and cardboard. The films are formed from, for example, one or two components selected from a group consisting of polyethylene terephthalate (PET), polyethylene (PE), low-density polyethylene (LDPE), high-density polyethylene (HDPE), polypropylene (PP), oriented polypropylene (OPP), SiOx vapor-deposited film, ethylene-vinyl acetate copolymer (EVA), ethylene-methacrylic acid copolymer (EMMA), polybutene (PB), polybutadiene (BDR), polymethylpentene (PMP), polyethylene naphthalate (PEN), polybutylene terephthalate (PBT), polyimide (PI), polyetherimide (PEI), polyether ketone (PEK), polyether ether ketone (PEEK), nylon (NY), polyamide (PA), polycarbonate (PC), polystyrene (PS), foamed polystyrene (FS/EPS), polyvinyl chloride (PVC), polyvinylidene chloride (PVDC), ethylene-vinyl alcohol copolymer (EVOH), polyvinyl alcohol (PVA), plain cellophane (PT), moisture-proof cellophane (MST), polyacrylonitrile (PAN), vinylon (VL), polyurethane (PU), and cellulose triacetate (TAC). The purpose of use of the media 2 is not particularly limited. Examples of such purpose of use of the media 2 may include, for example, industrial printing, paperboard, labels, and packaging such as packaging films.

### (Treatment Liquid)

The treatment liquid comprises a resin, a surfactant, and water. However, the treatment liquid may not comprise a surfactant. The treatment liquid is, for example, a clear ink. The clear ink is an aqueous ink containing a resin as a solid component. The clear ink is used, for example, to provide glossiness and/or improve print quality.

### (Resin)

The resin is not particularly limited. Examples of the resin may include, for example, acrylic resins, urethane resins, vinyl chloride resins, polyester resins, styrene resins, polyolefin resins, vinyl acetate resins, butadiene resins, benzoguanamine resins, phenolic resins, silicone resins, epoxy resins, paraffin resins, fluorine resins, water-soluble resins, and copolymers thereof.

Examples of the acrylic resins may include, for example, polymers of acrylic monomers such as acrylic acid and acrylic esters and copolymers of acrylic monomer(s) and other monomer(s). Examples of the copolymers of acrylic monomer(s) and other monomer(s) may include, for example, acrylic ester copolymers, styrene-acrylic copolymers, and silicone-acrylic copolymers. A commercially available acrylic resin may be used. Examples of the commercially available acrylic resin may include, for example, Mowinyl® 6820 (glass transition temperature: 35° C.), Mowinyl® 6969D (glass transition temperature: 71° C.), Mowinyl® 6760 (glass transition temperature: 0° C.) (all available from Japan Coating Resin Corporation), and POLYSOL® AP-3720N (glass transition temperature: 9° C.) (available from Resonac Corporation).

Examples of the urethane resins may include, for example, copolymers of monomers containing polyisocyanate and a diol compound or a bisphenol compound. Polyisocyanate may, for example, be diisocyanate. Diisocyanate may, for example, be aliphatic diisocyanate, alicyclic diisocyanate, or aromatic diisocyanate. A commercially available urethane resin may be used. Examples of the commercially available urethane resin may include, for example, SUPERFLEX® 860 (glass transition temperature: 78° C.), SUPERFLEX® 210 (glass transition temperature: 41° C.), SUPERFLEX® 500M (glass transition temperature: −39° C.) (all available from DKS Co., Ltd.), and PERMARIN® UA-368 (glass transition temperature: −20° C.) (available from Sanyo Chemical Industries, Ltd.).

Examples of the vinyl chloride resins may include, for example, vinyl chloride polymers and copolymers of vinyl chloride monomer(s) and other monomer(s). A commercially available vinyl chloride resin may be used. The commercially available vinyl chloride resin may, for example, be VINYBLAN® 700 (glass transition temperature: 70° C.) (available from Nisshin Chemical Industry Co., Ltd.).

Examples of the polyester resins may include, for example, condensation polymers of polycarboxylic acid and polyvinyl alcohol. Polycarboxylic acid may, for example, be dicarboxylic acid. Polyvinyl alcohol may, for example, be diol. A commercially available polyester resin may be used. The commercially available polyester resin may, for example, be PESRESIN A-640 (glass transition temperature: 64° C.) (available from TAKAMATSU OIL & FAT Co., Ltd.).

The resin may comprise resin particles. The resin particles may be incorporated, for example, in an emulsion. The emulsion comprises, for example, the resin particles and water. The resin particles are not dissolved in water but are dispersed in water while having particle diameters within a predetermined range. The average particle diameter of the resin particles is not particularly limited. The average particle diameter of the resin particles is, for example, in the range of 30 nm or more to 200 nm or less or in the range of 50 nm or more to 160 nm or less. The average particle diameter of the resin particles can be measured as an arithmetic average diameter using a dynamic light scattering particle size distribution analyzer LB-550 available from HORIBA, Ltd.

The resin may be a single resin or a combination of two or more resins. The content of the resin solid component is, for example, 0.1 wt % or more and 30 wt % or less, 0.5 wt % or more and 20 wt % or less, or 1.0 wt % or more and 15.0 wt % or less, based on the total amount of the treatment liquid.

The glass transition temperature of the resin is not particularly limited. The lower limit of the glass transition temperature is, for example, −50° C. or more, −30° C. or more, 0° C. or more, 20° C. or more, or 40° C. or more. The upper limit of the glass transition temperature is, for example, 120° C. or less, 110° C. or less, 100° C. or less, 90° C. or less, or 80° C. or less. Any upper and lower limits above can be combined as desired to set a range of glass transition temperature. The range of glass transition temperature is, for example, from −50° C. or more to 120° C. or less, from −30° C. or more to 110° C. or less, from 0° C. or more to 100° C. or less, from 20° C. or more to 90° C. or less, or from 40° C. or more to 80° C. or less. In order to suitably reduce the slipperiness of the media 2 by applying the treatment liquid to the media 2 and then performing the corona discharge to the region of each medium 2 where the treatment liquid has been applied, the glass transition temperature may be 9° C. or more.

### (Surfactant)

The surfactant is not particularly limited. The surfactant can be selected as desired based on the intended use. Examples of the surfactant may include, for example, anionic surfactants, nonionic surfactants, cationic surfactants, amphoteric surfactants, acetylenic glycol-based surfactants, fluorinated surfactants, and silicone-based surfactants.

Examples of the anionic surfactants may include, for example, salts of alkylsulfo-carboxylic acids, salts of alpha-olefin sulfonic acids, salts of polyoxyethylene alkyl ether acetates, salts of polyoxyethylene alkyl ether sulfates, N-acyl amino acids, or salts thereof. Examples of the nonionic surfactants may include, for example, polyols, glycol ethers, polyoxyethylene alkyl ethers, polyoxyethylene alkyl esters, and acetylenic glycols. Examples of the cationic surfactants may include, for example, 2-vinylpyridine derivatives and poly(4-vinylpyridine) derivatives. Examples of the amphoteric surfactants may include, for example, lauryl dimethylaminoacetate betaines, 2-alkyl-N-carboxymethyl-N-hydroxyethylimidazolinium betaines, coconut fatty-acid amido-propyl dimethylaminoacetate betaines, polyoctyl polyaminoethyl glycines, and imidazoline derivatives. Examples of the acetylenic glycol-based surfactants may include, for example, 2,4,7,9-tetramethyl-5-decyn-4, 7-diol, alkylene oxide adducts of 2,4,7,9-tetramethyl-5-decyn-4, 7-diol and the like, 2,4-dimethyl-5-decyn-4-ol, and alkylene oxide adducts of 2,4-dimethyl-5-decyn-4-ol. Examples of the silicone-based surfactants may include, for example, polyether-modified siloxanes and polyether-modified polydimethylsiloxanes. Examples of the fluorinated surfactants may include, for example, perfluoroalkylsulfonic acid compounds, perfluoroalkyl carboxylic acid compounds, perfluoroalkyl phosphate ester compounds, perfluoroalkyl ethylene oxide adducts, and polyoxyalkylene ether polymer compounds having perfluoroalkyl ether groups in the side chains.

A commercially available surfactant may be used. Examples of the commercially available surfactant may include, for example, OLFINE® E1004, OLFINE® E1008, OLFINE® E1010, SILFACER SAG002, SAG005, and SAG503A (all available from Nisshin Chemical Industry Co., Ltd.); SURFYNOL® 440, SURFYNOL® 465, SURFYNOL® 485, DYNOL® 960, DYNOL® 980, TEGOTwin 4000, and TEGOWet KL245 (all available from Evonik Industries); ACETYLENOL® E40 and ACETYLENOL® E100 (both available from Kawaken Fine Chemical Co., Ltd.); BYK-345, BYK-347, BYK-348, BYK-349, BYK-3420, BYK-3455, BYK-3456, LP-X23288, LP-X23289, and LP-X23347 (all available from BYK-Chemie).

The surfactant may be a single surfactant or a combination of two or more surfactants. The surfactant content relative to the total amount of the treatment liquid is not particularly limited. A range of the surfactant content is, for example, from 0.1 wt % or more to 20 wt % or less, from 0.15 wt % or more to 10 wt % or less, or from 0.2 wt % or more to 5.0 wt % or less based on the total amount of the treatment liquid. The surfactant content in any of the above-listed ranges can provide suitable wettability to the treatment liquid.

### (Water)

Water may, for example, ion-exchange water or pure water. The water content relative to the total amount of the treatment liquid is, for example, the remainder excluding the other components.

### (Other Components)

The treatment liquid may further comprise a water-soluble organic solvent as another component.

### (Water-Soluble Organic Solvent)

The water-soluble organic solvent is not particularly limited. Examples of the water-soluble organic solvent may include, for example, alkyl alcohols having 1 to 4 carbon atoms such as methanol, ethanol, n-propanol, isopropanol, n-butanol, sec-butanol and tert-butanol; alkylene glycols with alkylene groups having 2 to 6 carbon atoms such as ethylene glycol, propylene glycol, butylene glycol, 1,2-butanediol, triethylene glycol, 1,6-hexanediol, 1,2,6-hexanetriol, thiodiglycol, hexylene glycol, diethylene glycol; lower alkyl ethers of alkylene glycols such as glycerin, ethylene glycol monomethyl (or monoethyl, monopropyl, monobutyl) ethers, diethylene glycol monomethyl (or monoethyl, monopropyl, monobutyl) ethers, triethylene glycol monomethyl (or monoethyl, monopropyl, monobutyl, monohexyl) ethers, tetraethylene glycol monomethyl (or monoethyl, monopropyl, monobutyl, monohexyl) ethers, propylene glycol monomethyl (or monoethyl, monopropyl, monobutyl) ethers, dipropylene glycol monomethyl (or monoethyl, monopropyl, monobutyl) ethers, tripropylene glycol monomethyl (or monoethyl, monopropyl, monobutyl) ethers, and tetrapropylene glycol monomethyl (or monoethyl) ethers; N-methyl-2-pyrrolidone, 2-pyrrolidone and 1,3-dimethyl-2-imidazolidinone.

The water-soluble organic solvent may be a single water-soluble organic solvent or a combination of two or more water-soluble organic solvents. If the treatment liquid comprises the water-soluble organic solvent, the water-soluble organic solvent content relative to the total amount of the treatment liquid is not particularly limited. A range of the water-soluble organic solvent content is, for example, from 1.0 wt % or more to 95 wt % or less, from 5.0 wt % or more to 80 wt % or less, or from 10 wt % or more to 50 wt % or less.

The treatment liquid may further comprise conventionally known additive(s) as needed. Examples of the additive(s) may include, for example, pH adjusters, viscosity modifiers, and preservatives. Examples of the viscosity modifiers may include, for example, polyvinyl alcohol, cellulose, and water-soluble resins.

The treatment liquid can be prepared, for example, by uniformly mixing the resin, the surfactant, water, and other additive(s) if needed, by a publicly known method and then removing undissolved solids through a filter.

### (Surface Treatment Method)

Now, a surface treatment method with the surface treatment apparatus 10 is described. The surface treatment method comprises an application step and a discharge step. The application step and the discharge step are sequentially performed in this order. The controller 26 starts the steps, for example, in response to a process execution instruction being input to the surface treatment apparatus 10 from an external. When the above instruction is input, the controller 26 controls the units, such as the feed roller 16 and the conveyor 18, to convey the media 2 along the conveyance path 100.

### (Application Step)

In the application step, the treatment liquid is applied to a surface of a medium 2. The controller 34 controls the roller 32 based on instructions from the controller 26. The controller 34 rotates the roller 32 to which the treatment liquid adheres to apply the treatment liquid to the medium 2. The treatment liquid is thereby applied to the entire surface of the medium 2.

### (Discharge Step)

In the discharge step, a corona discharge is performed on at least the region of the medium 2 where the treatment liquid has been applied. The controller 44 controls the charging-voltage applying circuit and the grid-voltage applying circuit based on instructions from the controller 26 to generate the corona discharge. The corona discharge is thereby performed on at least the region of the medium 2 where the treatment liquid has been applied.

The corona discharge intensity in the discharge step is not particularly limited. The lower limit of the intensity is, for example, 5 W·min/m² or more, 10 W·min/m² or more, 20 W·min/m² or more, or 50 W·min/m² or more. The upper limit of the intensity is, for example, 100000 W·min/m² or less, 50000 W·min/m² or less, 10000 W·min/m² or less, or 8000 W·min/m² or less. Any upper and lower limits above can be combined as desired to set an intensity range. The intensity range is, for example, from 5 W·min/m² or more to 100000 W·min/m² or less, from 10 W·min/m² or more to 50000 W·min/m² or less, from 20 W·min/m² or more to 10000 W·min/m² or less, or from 50 W·min/m² or more to 8000 W·min/m² or less. In order to reduce slipperiness of the medium 2 by the corona discharge, the intensity may be 10 W·min/m² or more. In order to suppress discoloration or deformation of the medium 2 due to the corona discharge, the intensity may be 10000 W·min/m² or less.

The above surface treatment method can be used to adjust the slipperiness of the media 2. For example, in the surface treatment apparatus 10 according to this embodiment, the feed roller 16 needs to feed only the uppermost medium 2 among the media 2 supported on the feed tray 14. Thus, the media 2 are required to have relatively high slipperiness. In contrast, the media 2 may be stacked on a pallet and the pallet may be transferred. In this case, if the media 2 has relatively high slipperiness, the stack of media 2 may tilt during transport. To avoid this, it may be conceivable to secure the stack of media 2 on the pallet with a belt. However, this increases costs and work effort. Thus, in some situations the media 2 are required to have relatively high slipperiness, whereas in other situations the media 2 are required to have relatively low slipperiness. The above surface treatment method enables adjustment of the slipperiness of the media 2.

According to the above surface treatment method, the treatment liquid comprising the resin is first applied to the medium 2 in the application step. A resin layer containing the resin in a relatively large amount is thereby formed on a surface of the medium 2. Subsequently, in the discharge step, the corona discharge is performed on at least the region of the medium 2 where the treatment liquid has been applied. When electrons emitted by the corona discharge collide with molecules in ambient air, oxygen radicals or ozone are generated. Further, when the electrons emitted by the corona discharge reach the resin layer, polymer main chain and/or side chains of the resin in the resin layer are cleaved. The cleaved main chain and/or side chains react with the oxygen radicals or ozone in the ambient air, thereby introducing polar groups such as hydroxyl, carbonyl, and carboxyl groups onto the surface of the resin layer. This increases the surface free energy of the medium 2, increasing adhesion of the medium 2 to another medium and reducing the slipperiness of the medium 2. Further, the application of the treatment liquid comprising the resin to the medium 2 in the application step allows for formation of the resin layer on the medium 2 to which polar groups can be introduced by the corona discharge in the discharge step, regardless of the type of medium 2. Thus, the above surface treatment method can reduce the slipperiness of various types of media 2.

### (Correspondence Relationships)

The surface treatment apparatus 10 is an example of “manufacturing apparatus configured to manufacture a treated medium by performing a treatment on a medium”. The surface treatment method is an example of “method of manufacturing a treated medium by performing a treatment on a medium”. The treatment liquid is an example of “liquid”.

### EXAMPLES

Now, the treatment liquid is described more specifically using examples and comparative examples. It should be noted that the invention is not limited to these examples.

### (Preparation of Treatment Liquid)

Treatment liquids 1 to 13 were prepared by mixing the components shown in Tables 1 and 2. For the treatment liquids, the resins shown in the resin sections in Tables 1 and 2 were used. The same applies to the color materials. The surfactant was used for the treatment liquids of which surfactant sections in Tables 1 and 2 indicate “Present”. The same applies to water. In Tables 1 and 2, “-” means that the component corresponding to that section was not used. For example, the treatment liquid 1 was prepared by mixing an acrylic resin A as the resin, the surfactant, and water. In Tables 1 and 2, “Tg” means the glass transition temperature of resin. Further, the resin-dispersed magenta pigment in Table 2 is an aqueous dispersion of C.I. Pigment Red 122 (containing a resin dispersant).

TABLE 1

| | Treatment | Treatment | Treatment | Treatment | Treatment | Treatment | Treatment |
|---|---|---|---|---|---|---|---|
| | Liquid 1 | Liquid 2 | Liquid 3 | Liquid 4 | Liquid 5 | Liquid 6 | Liquid 7 |
| Resin | Acrylic | Acrylic | Acrylic | Acrylic | Urethane | Urethane | Urethane |
| | Resin A*¹ | Resin B*² | Resin C*³ | Resin D*⁴ | Resin A *⁵ | Resin B*⁶ | Resin C*⁷ |
| | (Tg: 35° C.) | (Tg: 71° C.) | (Tg: 9° C.) | (Tg: 0° C.) | (Tg: 78° C.) | (Tg: 41° C.) | (Tg: −20° C.) |
| Color | — | — | — | — | — | — | — |
| Material | | | | | | | |
| Surfactant | Present | Present | Present | Present | Present | Present | Present |
| Water | Present | Present | Present | Present | Present | Present | Present |

*¹Mowinyl 6820,
*²Mowinyl 6969D,
*³POLYSOL AP-3720N,
*⁴Mowinyl 6760,
*⁵SUPERFLEX 860,
*⁶SUPERFLEX 210,
*⁷PERMARIN UA-368

TABLE 2

| | Treatment | Treatment | Treatment | Treatment | Treatment | Treatment |
|---|---|---|---|---|---|---|
| | Liquid 8 | Liquid 9 | Liquid 10 | Liquid 11 | Liquid 12 | Liquid 13 |
| Resin | Urethane Resin D*⁸ | Vinyl Chloride Resin*⁹ | Polyester Resin*¹⁰ | Acrylic Resin A*¹ | Acrylic Resin A*¹ | — |
| | (Tg: -39° C.) | (Tg: 70° C.) | (Tg: 64° C.) | (Tg: 35° C.) | (Tg: 35° C.) | |
| Color Material | — | — | — | Resin-dispersed | — | Resin-dispersed |
| | | | | Magenta Pigment | | Magenta Pigment |
| Surfactant | Present | Present | Present | Present | — | Present |
| Water | Present | Present | Present | Present | Present | Present |

*¹Mowinyl 6820,
*⁸SUPERFLEX 500M,
*⁹VINYBLAN 700,
*¹⁰PESRESIN A-640

Sliding angles of the media 2 were evaluated according to the method described below, using the treatment liquids of examples and comparative examples. The coated cardboard in Tables 3 and 4 is OK Ball EM (basis weight: 350 g/m²) available from Oji Materia Co., Ltd. The PET in Table 4 is polyethylene terephthalate film (thickness: 38 μm) available from Toppan Printing Co., Ltd.

### (Preparation of Evaluation Samples)

For examples 1 to 18 and comparative example 1, evaluation samples were prepared by applying the treatment liquids to surfaces of the media 2 using a bar coater (depth: 18 μm) available from OSG System Products Co., Ltd. and then performing a corona discharge with the intensities shown in Tables 3 and 4 on the regions of the media 2 where the treatment liquids have been applied. For comparative example 2, an evaluation sample was prepared by performing a corona discharge with the intensity shown in Table 4 on the medium 2 and then applying the treatment liquid to the corona-discharged region of the medium 2 using the same bar coater. Each evaluation sample had the size of 58 mm×180 mm.

### (Evaluation of Sliding Angle)

For each of the above evaluation samples, the sliding angle of the medium 2 was measured according to the inclined plane method defined in JIS P 8147:2010. This measurement was conducted at the temperature of 23° C. and relative humidity of 50% according to the standard conditions defined in JIS P 8111. For each of examples 1 to 18 and comparative example 1, a change in sliding angle of the medium 2 (i.e., how much the sliding angle changed after the corona discharge compared to before the corona discharge) was calculated. Specifically, for examples 1 to 18 and comparative example 1, reference samples were prepared by applying the same treatment liquids to the same media 2. The reference samples were not subjected to the corona discharge. Then, the changes in sliding angle were calculated by subtracting the sliding angles of the reference samples from the sliding angles of the evaluation samples for examples 1 to 18 and comparative example 1. For comparative example 2, a change in sliding angle was calculated using a reference sample prepared by applying the same treatment liquid to the same medium 2 (this reference sample was not subjected to the corona discharge, either). That is, the reference sample for comparative example 2 is the same as the reference sample for example 6. The media 2 of the examples and comparative examples were evaluated based on the calculated changes in sliding angle according to the criteria below. The evaluation results are shown in Tables 3 and 4. A medium 2 having a larger sliding angle is less slippery (i.e., has lower slipperiness). Further, a medium 2 having a larger change in sliding angle has become less slippery (i.e., has lower slipperiness).
A: Change in sliding angle ≥3.0°
B: 0.5°<Change in sliding angle <3.0°
C: Change in sliding angles≤0.5°.

TABLE 3

| | | Example1 | Example2 | Example3 | Example4 | Example5 |
|---|---|---|---|---|---|---|
| Treatment Liquid | | 1 | 2 | 3 | 4 | 5 |
| Medium | | Coated | Coated | Coated | Coated | Coated |
| | | Cardboard | Cardboard | Cardboard | Cardboard | Cardboard |
| Corona | Timing | After | After | After | After | After |
| Discharge | | Application | Application | Application | Application | Application |
| | | of | of | of | of | of |
| | | Treatment | Treatment | Treatment | Treatment | Treatment |
| | | Solution | Solution | Solution | Solution | Solution |
| | Discharge | 550 | 550 | 550 | 550 | 550 |
| | Intensity | | | | | |
| | [Wmin/m²] | | | | | |
| Evaluation | Result | A | A | A | B | A |
| | Sliding Angle [°] | 33.5 | 32.0 | 36.5 | 31.5 | 27.0 |
| | Change in | 9.3 | 4.0 | 5.0 | 1.8 | 3.0 |
| | Sliding Angle [°] | | | | | |
| | | Example6 | Example7 | Example8 | Example9 | Example10 |
| Treatment Liquid | | 6 | 7 | 8 | 9 | 10 |
| Medium | | Coated | Coated | Coated | Coated | Coated |
| | | Cardboard | Cardboard | Cardboard | Cardboard | Cardboard |
| Corona | Timing | After | After | After | After | After |
| Discharge | | Application | Application | Application | Application | Application |
| | | of | of | of | of | of |
| | | Treatment | Treatment | Treatment | Treatment | Treatment |
| | | Solution | Solution | Solution | Solution | Solution |
| | Discharge | 550 | 550 | 550 | 550 | 550 |
| | Intensity | | | | | |
| | [Wmin/m²] | | | | | |
| Evaluation | Result | A | B | B | A | A |
| | Sliding Angle [°] | 27.0 | 29.8 | 28.0 | 27.0 | 25.5 |
| | Change in | 3.0 | 2.0 | 2.5 | 4.0 | 5.8 |
| | Sliding Angle [°] | | | | | |

TABLE 4

| | | Example11 | Example12 | Example13 | Example14 | Example15 | Example16 |
|---|---|---|---|---|---|---|---|
| Treatment Liquid | | 11 | 12 | 1 | 1 | 1 | 1 |
| Medium | | Coated | Coated | Coated | Coated | Coated | PET |
| | | Cardboard | Cardboard | Cardboard | Cardboard | Cardboard | |
| Corona | Timing | After | After | After | After | After | After |
| Discharge | | Application | Application | Application | Application | Application | Application |
| | | of | of | of | of | of | of |
| | | Treatment | Treatment | Treatment | Treatment | Treatment | Treatment |
| | | Solution | Solution | Solution | Solution | Solution | Solution |
| | Discharge | 550 | 550 | 5 | 10 | 20 | 550 |
| | Intensity | | | | | | |
| | [Wmin/m²] | | | | | | |
| Evaluation | Result | A | A | B | A | A | A |
| | Sliding Angle [°] | 31.5 | 25.0 | 26.0 | 27.5 | 29.5 | 24.0 |
| | Change in | 4.8 | 4.0 | 1.8 | 3.3 | 5.3 | 10.0 |
| | Sliding Angle [°] | | | | | | |

| | | | | Comparative | Comparative |
|---|---|---|---|---|---|
| | | Example17 | Example18 | Example1 | Example2 |
| Treatment Liquid | | 1 | 1 | 13 | 6 |
| Medium | | PET | PET | Coated | Coated |
| | | | | Cardboard | Cardboard |
| Corona | Timing | After | After | After | Before |
| Discharge | | Application | Application | Application | Application |
| | | of | of | of | of |
| | | Treatment | Treatment | Treatment | Treatment |
| | | Solution | Solution | Solution | Solution |
| | Discharge | 5 | 10 | 550 | 550 |
| | Intensity | | | | |
| | [Wmin/m²] | | | | |
| Evaluation | Result | B | A | C | C |
| | Sliding Angle [°] | 16.0 | 19.0 | 27.0 | 24.5 |
| | Change in | 2.0 | 5.0 | −1.0 | 0.5 |
| | Sliding Angle [°] | | | | |

As shown in Tables 3 and 4, the samples of examples 1 to 18 yielded favorable results in the sliding-angle evaluation. The treatment liquids 1 to 12 used for examples 1 to 12 comprise different resins. Specifically, the treatment liquids 1 to 4 comprise acrylic resins, the treatment liquids 5 to 8 comprise urethane resins, the treatment liquid 9 comprises a vinyl chloride resin, and the treatment liquid 10 comprises a polyester resin. Thus, the technology disclosed herein can be applied to treatment liquids comprising various types of resins.

The media 2 of examples 16 to 18 are different from those of examples 1 and 13 to 15. Specifically, the coated cardboard is used as the media 2 in examples 1 and 13 to 15, while the PET is used as the media 2 in examples 16 to 18. The samples of examples 16 to 18 yielded the results substantially as good as the samples of examples 1 and 13 to 15 in the sliding-angle evaluation. Thus, the technology disclosed herein can be applied to various types of media.

In contrast, the sample of comparative example 1 yielded an inferior result in the sliding-angle evaluation compared to the samples of examples 1 to 12. The sample of comparative example 1 is different from those of examples 1 to 12 only in the treatment liquid used. Specifically, the treatment liquid 13 used for comparative example 1 does not comprise a resin, while the treatment liquids 1 to 12 used for examples 1 to 12 comprise resins. Applying the treatment liquid 13 used for comparative example 1 to a surface of medium 2 does not result in formation of a resin layer containing a resin in a relatively large amount on the surface of the medium 2. Therefore, even when the corona discharge is performed on the region of the medium 2 where the treatment liquid has been applied, the surface of the medium 2 is unlikely to be chemically radicalized and polar groups are unlikely to be introduced. In contrast, applying the treatment liquids 1 to 12 used for examples 1 to 12 to the media 2 result in formation of resin layers containing the resins in relatively large amounts on surfaces of the media 2. When the corona discharge is subsequently performed, electrons emitted by the corona discharge collide with molecules in ambient air, thereby generating oxygen radicals or ozone. Further, when the electrons emitted by the corona discharge reach the resin layers, polymer main chains and/or side chains of the resins in the resin layers are cleaved. The cleaved main chains and/or side chains react with the oxygen radicals or ozone in the ambient air, thereby introducing polar groups such as hydroxyl, carbonyl, and carboxyl groups onto the surfaces of the resin layers. This increases the surface free energy of the media 2 of examples 1 to 12, increasing adhesion of the media 2 to another medium and reducing the slipperiness of the media 2. Further, the application of the treatment liquids comprising the resins to the media 2 allows for formation of the resin layers on the media 2 to which polar groups can be introduced subsequently by the corona discharge, regardless of the types of media 2. Thus, the technology disclosed herein can reduce slipperiness of various types of media 2.

The sample of comparative example 2 yielded an inferior result in the sliding-angle evaluation compared to the sample of example 6. Comparative example 2 is different from example 6 in the order in which the application of treatment liquid to the medium 2 and the corona discharge are performed. Specifically, for comparative example 2, the corona discharge is performed on the surface of medium 2 and then the treatment liquid is applied to the corona-discharged region of the medium 2, while for example 6, the treatment liquid is applied to the medium 2 and then the corona discharge is performed on the region of the medium 2 where the treatment liquid has been applied. From example 6 and comparative example 2, it has been found that the slipperiness of medium 2 can be favorably reduced by applying a treatment liquid comprising a resin to the medium 2 and then performing the corona discharge subsequently.

Now, the examples are compared and evaluated. The treatment liquids used for examples 1 to 12 comprise different resins. Due to this resin difference, the glass transition temperature of resin is different among examples 1 to 12. Among examples 1 to 12, the samples of examples 1 to 3, 5, 6, and 9 to 12 yielded more favorable results in the sliding-angle evaluation. The glass transition temperatures of resins contained in the treatment liquids 4, 7, and 8 used for examples 4, 7, and 8 are relatively low. In contrast, the glass transition temperatures of resins contained in the treatment liquids 1 to 3, 5, 6, and 9 to 12 used for examples 1 to 3, 5, 6, and 9 to 12 are relatively high and are all 9° C. or more. A resin having a lower glass transition temperature is more likely to become rubbery at the temperature for the sliding angle measurement (i.e., 23° C.), increasing the flexibility of resin layer. As a result, the resin layer on the surface of medium 2 exhibits an increased adhesion to the inclined plane. Therefore, it is considered that the effect of the resin layer flexibility on the slipperiness of media 2 predominates over the effect of corona discharge on the slipperiness of media 2 in examples 4, 7, and 8 for which the treatment liquids comprising resins having low glass transition temperatures were used. That is, it is considered that the samples of examples 4, 7, and 8 yielded relatively inferior results in the sliding-angle evaluation because the effect of corona discharge on the slipperiness of media 2 was relatively small, and this led to small changes in sliding angle. Thus, it has been found that the slipperiness of medium 2 can be favorably reduced by using a resin having a moderately high glass transition temperature in a treatment liquid.

The treatment liquid 1 used for example 1 is different from the treatment liquid 12 used for example 12 in that the former comprises the surfactant. The sample of example 1 yielded a more favorable result in the sliding-angle evaluation compared to the sample of example 12. When the treatment liquid 1 comprising the resin and surfactant is applied to a surface of medium 2, a resin layer is formed on the surface of medium 2, and this resin layer contains the resin and surfactant in relatively large amounts. When the corona discharge is subsequently performed, polymer main chain and/or side chains of the resin as well as polymer main chain and/or side chains of the surfactant are cleaved. The cleaved main chains and/or side chains of the resin and surfactant react with oxygen radicals or ozone in ambient air, thereby introducing more polar groups onto the surface of the resin layer. This increases the surface free energy of the medium 2, increasing adhesion of the medium 2 to another medium, which led to the favorable result in the sliding-angle evaluation.

The corona discharge intensity is different among examples 1 and 13 to 15. From examples 1 and 13 to 15, it has been confirmed that a greater corona discharge intensity brings about a larger change in sliding angle. Especially, the samples of examples 1, 14, and 15 treated with corona discharge intensities of 10 W·min/m² or more yielded more favorable results in the sliding-angle evaluation. This is because with a greater corona discharge intensity, more polymer main chains and/or side chains of the resin in the resin layer are cleaved by electrons emitted by the corona discharge. The cleaved more main chains and/or side chains react with oxygen radicals or ozone in ambient air, thereby introducing more polar groups onto the surface of the resin layer. This increases the surface free energy of the media 2, increasing adhesion of the media 2 to another medium, which led to the favorable results in the sliding-angle evaluation.

In above-described examples 1 and 13 to 15, the coated cardboard is used as the media 2. It has been confirmed that a greater corona discharge intensity brings about a larger change in sliding angle even in a different medium from those used for examples 1 and 13 to 15. Specifically, it has been confirmed that a greater corona discharge intensity brings about a larger change in sliding angle in the PET used as the media 2 for examples 16 to 18. Especially, the samples of examples 16 and 18 treated with corona discharge intensities of 10 W·min/m² or more yielded more favorable results in the sliding-angle evaluation. Thus, the slipperiness of medium 2 can be suitably reduced by using a moderately great corona discharge intensity, regardless of the type of medium 2.

Among examples 1 to 18, the samples of examples 1 to 3, 5, 6, 9 to 12, 14 to 16, and 18 yielded more favorable results in the sliding-angle evaluation. Examples 1 to 3, 5, 6, 9 to 12, 14 to 16, and 18 are common in using corona discharge intensities of 10 W·min/m² or more and in using resins having the glass transition temperatures of 9° C. or more in the treatment liquids. Thus, the slipperiness of medium 2 can be suitably reduced by using a moderately great corona discharge intensity and by using a resin having a moderately high glass transition temperature in a treatment liquid, regardless of the type of medium 2 and whether the treatment liquid comprises a surfactant and/or color material.

While the invention has been described in conjunction with various example structures outlined above and illustrated in the FIGURES, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### Modification 1

In the embodiment above, the treatment liquid may further comprise a color material. That is, in the application step, the treatment liquid comprising a color material may be applied to the media 2 to form images thereon. Then, in the discharge step, the corona discharge may be performed on at least the regions of the media 2 where the treatment liquid has been applied. The treatment liquid comprising a color material is also an example of “liquid”. Examples of the color material may include, for example, pigments dispersible in water with an aid of resin dispersant and self-dispersible pigments dispersible in water.

### Modification 2

In the embodiment above, the applier 30 may comprise a stamp, a brush, or a head instead of the roller 32. In other words, the application step may be performed using the stamp, the brush, or the head instead of the roller 32. That is, the liquid may be applied to the media 2 by a publicly known method such as a spray coating method, a blade coating method, a roll coating method, an inkjet method, and a dip coating method. If the treatment liquid comprising a color material is applied to the media 2 in the application step as described in the above modification, the treatment liquid may be selectively applied only to portions of the media 2 that require the application. In this case, the inkjet method can be suitably used.

### Modification 3

In the embodiment above, the surface treatment apparatus 10 may comprise a roller configured to support the medium 2 and another roller configured to wind up the medium 2 instead of the feed tray 14, the feed roller 16, and the feed-out tray 24. In other words, the surface treatment apparatus 10 may use a roll-to-roll approach.

### Modification 4

In the embodiment above, the surface treatment apparatus 10 may not comprise the discharger 40. In this case, after the treatment liquid has been applied to the media 2 by the applier 30 of the surface treatment apparatus 10, the corona discharge may be performed on the regions of the media 2 where the treatment liquid has been applied by the discharger 40 which is a separate component from the surface treatment apparatus 10.

### Modification 5

In the embodiment above, the surface treatment apparatus 10 may further comprise a dryer configured to dry the treatment liquid on the media 2 conveyed along the conveyance path 100. In this case, the dryer may be located downstream of the applier 30 and upstream of the discharger 40 on the conveyance path 100. The dryer may comprise, for example, a drying device, a heat gun, an oven, or an IR heater. Instead of adding the dryer, the media 2 may be left for a predetermined period after the treatment liquid has been applied thereto in the surface treatment apparatus 10, so that a predetermined amount of the water content in the treatment liquid can be evaporated. That is, after the treatment liquid has been applied to the media 2 in the surface treatment apparatus 10, the treatment liquid on the media 2 may be naturally dried without the use of a dryer. In other words, the surface treatment method may comprise a drying step after the application step and before the discharge step.

What is claimed is:

1. A method of manufacturing a treated medium by performing a treatment on a medium, the method comprising:
applying a liquid comprising a resin to the medium; and
performing a corona discharge on at least a region of the medium where the liquid has been applied.

2. The method according to claim 1, wherein an intensity of the corona discharge is 10 W·min/m² or more.

3. The method according to claim 1, wherein a glass transition temperature of the resin is 9° C. or more.

4. The method according to claim 1, wherein
an intensity of the corona discharge is 10 W·min/m² or more, and
a glass transition temperature of the resin is 9° C. or more.

5. The method according to claim 1, wherein the liquid further comprises a surfactant.

6. The method according to claim 1, wherein the liquid further comprises a color material.

7. A manufacturing apparatus configured to manufacture a treated medium by performing a treatment on a medium, the manufacturing apparatus comprising:
an applier configured to apply a liquid comprising a resin to the medium; and
a discharger configured to perform a corona discharge on at least a region of the medium where the liquid has been applied.

8. The manufacturing apparatus according to claim 7, wherein the discharger is configured to perform the corona discharge with an intensity of 10 W·min/m² or more.

9. The manufacturing apparatus according to claim 7, wherein the applier is configured to apply, to the medium, the liquid comprising the resin having a glass transition temperature of 9° C. or more.

10. The manufacturing apparatus according to claim 7, wherein
the discharger is configured to perform the corona discharge with an intensity of 10 W·min/m² or more, and
the applier is configured to apply, to the medium, the liquid comprising the resin having a glass transition temperature of 9° C. or more.

11. The manufacturing apparatus according to claim 7, wherein the applier is configured to apply, to the medium, the liquid further comprising a surfactant.

12. The manufacturing apparatus according to claim 7, wherein the applier is configured to apply, to the medium, the liquid further comprising a color material.
